(19) United States
(12) Patent Application Publication
(10) Pub. No.: US 2011/0206345 A1
(43) Pub. Date: Aug. 25, 2011

(54) Playback Apparatus and Playback Method

(76) Inventor: Yoko Masuo, Iruma-shi (JP)

(21) Appl. No.: 12/969,398

(22) Filed: Dec. 15, 2010

(30) Foreign Application Priority Data
Feb. 22, 2010 (JP) 2010-036502

(51) Int. Cl. H04N 9/80

(52) U.S. Cl. 386/239; 386/E09.011

(57) ABSTRACT

According to one embodiment, a playback apparatus includes: a sound information input module configured to receive a surrounding environmental sound as sound information; a sound information management module configured to manage feature information of noticeable environmental sounds; a sound information analysis module configured to analyze the received sound information; a notification information creation module configured to create notification information when the received sound information coincides with the feature information of one of the noticeable environmental sounds; and an output control module configured to output video or audio by superposing the created notification information thereon.

### CROSS-REFERENCE TO RELATED APPLICATION(S)

This application is based upon and claims the benefit of priority from Japanese Patent Application No. 2010-036502, filed on Feb. 22, 2010, the entire contents of which are incorporated herein by reference.

### FIELD

Embodiments described herein relate generally to a playback apparatus and a playback method for playing back video, audio, etc.

### BACKGROUND

There are lots of contrivances for discriminating necessary components in a surrounding environmental sound from unnecessary components quite similar to the necessary components. For example, JP-H09-026354-A is aimed at discrimination between a notification sound such as door chimes, phone rings, etc. and an acoustic output of a television set, etc. JP-H09-026354-A discloses an apparatus including a microphone for collecting an ambient sound and a module for monitoring an acoustic output, and the apparatus notifies a user when a sound similar to one of previously-stored notification sounds is detected.

In JP-H09-026354-A, a module for monitoring and comparing acoustic components contained in a content is provided, and the module is operated all the time. However, JP-H09-026354-A has not provided any specific method for detecting a sound similar to one of the notification sounds. Generally, it is difficult to uniquely specify an environmental sound, and therefore, the possibility of wrong detection is high.

Accordingly, there is a demand for a playback apparatus capable of notifying a user of an important environmental sound during playing back video, audio, etc., with a inexpensive, simpler and power saving configuration.

### BRIEF DESCRIPTION OF THE DRAWINGS

A general architecture that implements the various feature of the present invention will now be described with reference to the drawings. The drawings and the associated descriptions are provided to illustrate embodiments of the present invention and not to limit the scope of the present invention.

FIG. 1 illustrates an example system configuration of a digital television set according to an embodiment.

FIG. 2 illustrates an example processing flow in this embodiment.

FIG. 3 illustrates an example of a sound information database in this embodiment.

FIG. 4 illustrates a usage example (1) of the embodiment.

FIG. 5 illustrates a usage example (2) of the embodiment.

FIG. 6 illustrates a usage example (3) of the embodiment.

FIG. 7 illustrates an example block configuration of a television receiver according to the embodiment.

### DETAILED DESCRIPTION

In general, according to one embodiment, a playback apparatus includes: a sound information input module configured to receive a surrounding environmental sound as sound information; a sound information management module configured to manage feature information of noticeable environmental sounds; a sound information analysis module configured to analyze the received sound information; a notification information creation module configured to create notification information when the received sound information coincides with the feature information of one of the noticeable environmental sounds; and an output control module configured to output video or audio by superposing the created notification information thereon.

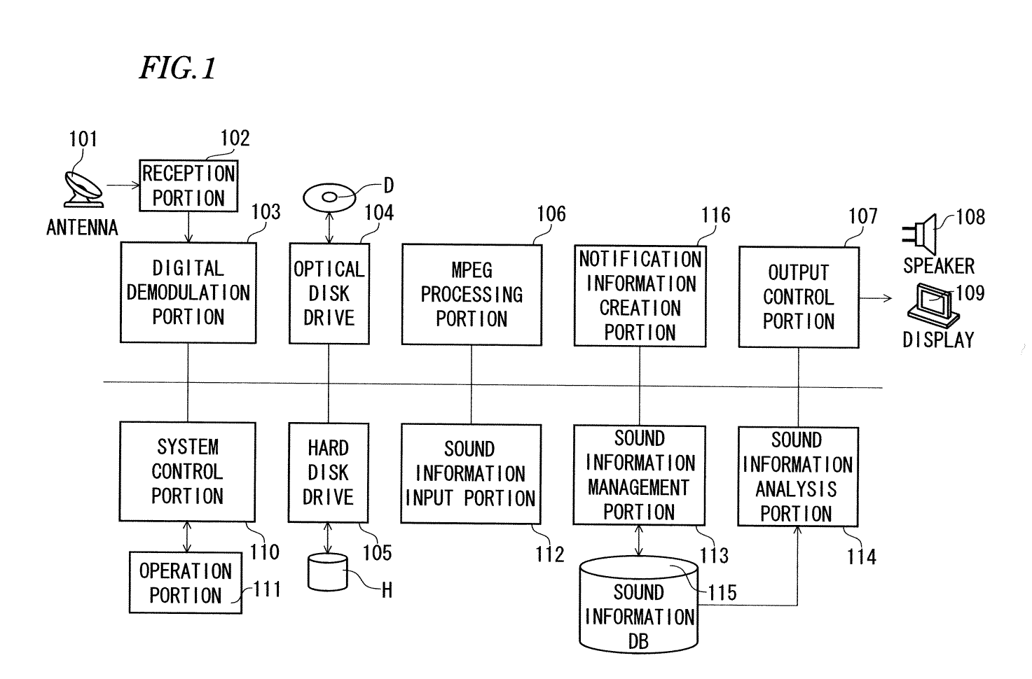

An embodiment will be described below with reference to FIGS. 1 to 7.

The embodiment can be applied to a digital media playback apparatus such as a digital television receiver, a car navigation apparatus, etc. having a function of playing back video and audio contents.

(Configuration and Operation of Broadcast Receiver)

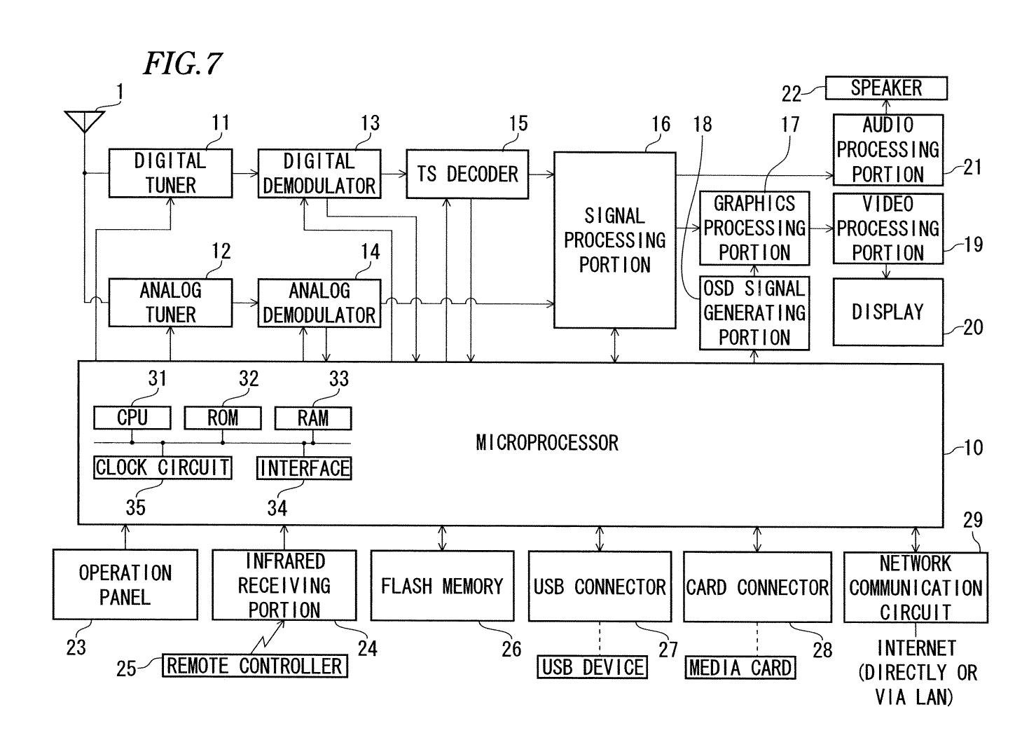

First, a (digital) television receiver according an embodiment will be described with reference to FIG. 7.

FIG. 7 illustrates an example block configuration of a digital television receiver to be used in a system illustrated in FIG. 1.

The television receiver can receive analog terrestrial broadcast waves and digital BS/CS/terrestrial broadcast waves. The television receiver includes a microprocessor 10, a digital tuner 11, an analog tuner 12, a digital demodulator 13, an analog demodulator 14 and a TS decoder 15.

Digital BS/CS/terrestrial broadcast waves are received by an antenna 1, and the signal of the received broadcast waves is fed to the digital tuner 11. Likewise, analog terrestrial broadcast waves are received by the antenna 1, and the signal of the received broadcast waves is fed to the analog tuner 12. Each of the digital tuner 11 and the analog tuner 12 uses a phase locked loop (PLL) technique to select desired broadcast waves in accordance with reception parameters (such as center frequency, bandwidth, etc.) designated under the control of the microprocessor 10.

For example, in digital terrestrial broadcasting in Japan, the signal of the received broadcast waves selected by the digital tuner 11 is fed to the OFDM (Orthogonal Frequency Division Multiplexing)-based digital demodulator 13 and the TS decoder 15 successively, and the signal is demodulated and decoded into digital video/audio signals by the digital demodulator 13 and the TS decoder 15. The signal of the received broadcast waves selected by the analog tuner 12 is fed to the analog demodulator 14, and the signal is demodulated into analog video/audio signals by the analog demodulator 14.

The television receiver further includes a signal processing portion 16, a graphics processing portion 17, an OSD (On Screen Display) signal generating portion 18, a video processing portion 19, a display 20, an audio processing portion 21, a speaker 22, an operation panel 23, an infrared receiving portion 24, a remote controller 25, a flash memory 26, a USB (Universal Serial Bus) connector 27, a card connector 28, and a network communication circuit 29. The signal processing portion 16 selectively applies digital signal processing to the digital video/audio signals fed from the TS decoder 15, and outputs the resulting video/audio signals to the graphics processing portion 17 and the audio processing portion 21 respectively. In addition, the signal processing portion 16 selectively digitizes the analog video/audio signals fed from the analog demodulator 14, applies digital signal processing to the digitized video/audio signals, and outputs the resulting video/audio signals to the graphics processing portion 17 and the audio processing portion 21 respectively.

The graphics processing portion 17 selectively superposes an OSD signal generated by the OSD signal generating portion 18 on the digital video signal outputted from the signal processing portion 16, and outputs the resulting signal to the video processing portion 19. The video processing portion 19 applies conversion processing such as size adjustment to suit the display 20 to the digital video signal outputted from the graphics processing portion 17. The display 20 displays video corresponding to the video signal outputted from the video processing portion 19. The audio processing portion 21 applies conversion processing such as volume control to suit the speaker 22 to the digital audio signal outputted from the signal processing portion 16. The speaker 22 reproduces audio corresponding to the audio signal outputted from the audio processing portion 21.

The microprocessor 10 receives an operation request from the operation panel 23 or from the remote controller 25 through the infrared receiving portion 24, and controls the respective components to reflect the requested operation. The operation panel or keyboard 23 and the remote controller 25 are functioning as operation modules which are user interfaces. As shown in FIG. 7, the microprocessor 10 includes a CPU (Central Processing Unit) 31, an ROM (Read Only Memory) 32, an RAM (Random Access Memory) 33, an interface 34, and a clock circuit 35. The CPU 31 performs various processes and controls. The ROM 32 holds control programs of the CPU 31 and various initial data. The RAM 33 provides a work area for temporarily storing input/output information of the CPU 31. The interface 34 inputs/outputs setting information and control information to/from the respective components through an I2C bus or the like. The clock circuit 35 is corrected in accordance with time information and date information acquired from broadcast waves or via a network.

The USB connector 27 is provided for connecting various USB devices. The card connector 28 is provided for connecting various media cards. In addition, the network communication circuit 29 is connected to the Internet directly or via an LAN (Local Area Network). The microprocessor 10 is capable of fetching the time information from broadcast waves received by the antenna 1. And, the microprocessor 10 is capable of fetching the fundamental data such as time information, weather and fortunetelling from the network via the network communication circuit 29.

For example, on a manufacturer side (in a shipping stage), the flash memory 26 as a nonvolatile memory may store BGM (preinstalled BGM) and various kinds of registration information for playing back the BGM.

By connecting a USB device (memory etc.) or a media card to the USB connector 27 or the card connector 28, moving pictures, photographs and music data can be read from the outside.

For example, to achieve a photo viewer function or a photo frame function, the microprocessor 10 fetches one or plural photographic images held as a file in a USB memory connected to the USB connector 27 or in a media card connected to the card connector 28, and controls the display 20 to display each photographic image via processing in the signal processing portion 16, the graphics processing portion 17 and the video processing portion 19.

An optical disk D or a hard disk H shown in FIG. 1 may be provided through the USB device. Further, the optical disk D or the hard disk H may form a sound information database 115. As video/audio of viewing/listening target, a content recorded on the optical disk D or the hard disk H may be played back.

A sound information input portion 112, a sound information management portion 113, a sound information analysis portion 114 and a notification information creation portion 116 shown in FIG. 1 may be configured by the CPU 31, the ROM 32 and the RAM 33 in the microprocessor 10, for example.

FIG. 1 illustrates an example system configuration of a digital television set according to an embodiment.

A television broadcast received by a reception portion 102 (corresponding to the digital tuner 11) via an antenna 101 (corresponding to the antenna 1) is once converted into an IF (Intermediate Frequency) signal. A digital demodulation portion 103 (corresponding to the digital demodulator 13 and the TS decoder 15) extracts a digital signal (TS: Transport Stream) from the IF signal and outputs the extracted digital signal to an MPEG processing portion 106 (corresponding to the signal processing portion 16, the video processing portion 19 and the audio processing portion 21). The MPEG processing portion 106 separates the TS into video, audio and SI (Service Information) for displaying an EPG, and decodes the video and audio. An output control portion 107 outputs the decoded video and audio data to a display 109 and a speaker 108.

A system control portion 110 (corresponding to the microprocessor 10) integrally controls the respective processing portions. The system control portion 110 receives various control commands transmitted from an external operation portion 111 such as a remote controller. For example, the control commands are instructions to play back/record a television broadcast and play back a recorded content. When an instruction to record a television broadcast is issued, the received broadcast content is encoded by the MPEG processing portion 106 and recorded on an optical disk D through an optical disk drive 104 or on a hard disk H through a hard disk drive 105. When an instruction to play back a content recorded on the optical disk D or the hard disk H is issued, the recorded content is decoded by the MPEG processing portion 106 and then outputted to the output control portion 107.

Further, in this embodiment, there are provided the sound information input portion 112, the sound information management portion 113, the sound information analysis portion 114, the sound information database 115 and the notification information creation portion 116.

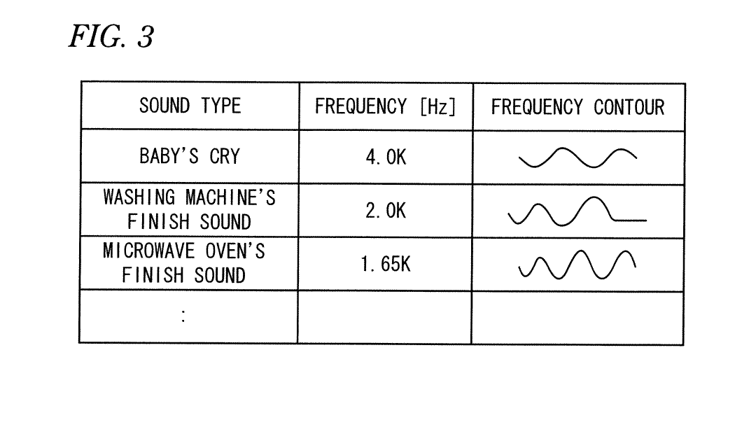

The sound information input portion 112 has a microphone or a receiver to collect surrounding environmental sounds. When a received is used in the sound information input portion 112, any one of wireless LAN, Bluetooth®, infrared communication and visible light communication may be used as a reception method of the receiver. In the sound information database 115, feature information of noticeable environmental sounds for the user is registered in advance. The sound information database 115 is managed by the sound information management portion 113. As shown in FIG. 3, the database includes information of one or more sound features such as frequency, frequency contour, etc. in accordance with the type of the sound. A sound acquired by the sound information input portion 112 is analyzed by the sound information analysis portion 114, so that sound features such as frequency, frequency contour, etc. extracted from the sound are collated with the sound information database 115. When the input sound coincides with sound features in the database, the input sound is amplified by the notification information creation portion 116, and the amplified sound is outputted to the output control portion 107 so that the amplified sound is superposed on original audio which is being listened to.

According to the above configuration, a noticeable environmental sound can be appropriately conveyed to the user so as not to be cancelled by audio of a content being played back.

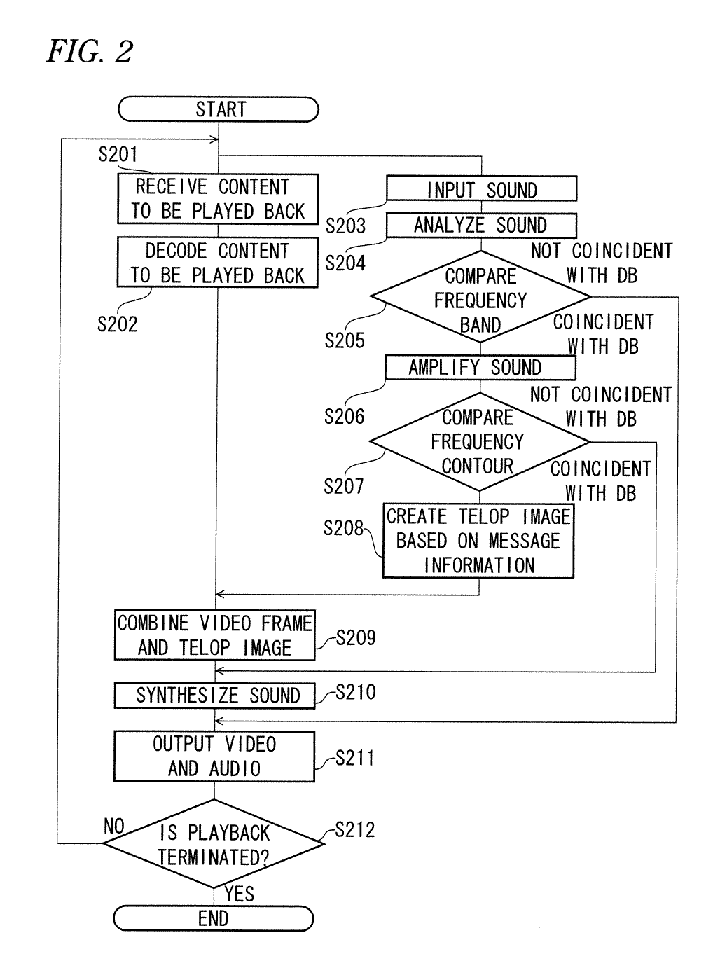

An example processing flow in this embodiment will be described below with reference to FIG. 2.

Step S201: The reception portion 102 receives a content to be played back.

Step S202: The digital demodulation portion 103 extracts a TS from the received content, and the MPEG processing portion 106 decodes the TS.

Step S203: The sound information input portion 112 collects a surrounding environmental sound in parallel with Steps S201 to S202.

Step S204: The sound information analysis portion 114 analyzes the sound collected in Step S203. Specifically, the sound information analysis portion 114 converts sound information into a digital sound signal by an AD converter, records the digital sound signal for a certain time, and then applies frequency analysis to the digital sound signal to extract feature information such as fundamental frequency, frequency contour, etc. from the digital sound signal.

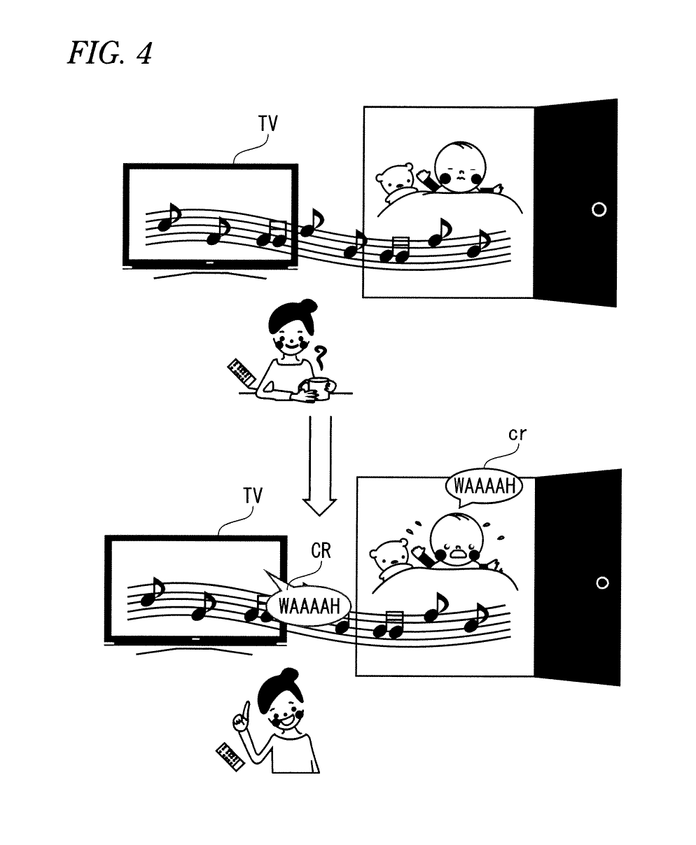

Steps S205 and S206: The notification information creation portion 116 amplifies the input sound when the frequency extracted in Step S204 coincides with the frequency band of one of the registered specific sounds in the sound information database 115. FIG. 4 exemplifies a case where a baby cry is amplified.

Steps S207 and S208: The notification information creation portion 116 creates a telop image corresponding to the type of the detected sound when the frequency contour extracted in Step S204 coincides with the frequency contour of one of the registered specific sounds in the sound information database 115 (when the type of the sound is specified uniquely). For example, in the case shown in FIG. 4, the notification information creation portion 116 creates a telop image indicating “a baby's cry is detected”.

By amplifying the original environmental sound itself in Step S206, the user may can determine what sound has generated. In this case, Steps S207 and S208 may be omitted.

Step S209: When there is any telop image created in Steps S207 and S208, the output control portion 107 combines the telop image with a content frame image decoded in Step S202.

Step S210: When there is any amplified sound created in Steps S205 and S206, the output control portion 107 combines the amplified sound with the content audio decoded in Step S202. On this occasion, the content audio may be relatively weakened, and the volume may be changed based on the reliability of the coincidence discrimination in Step S205.

Step S211: The video created in Step S209 and the audio created in Step S210 are outputted.

Step S212: Steps S201 to S211 are repeated until playback of the content is completed.

Next, FIG. 3 illustrates an example of the sound information database, in which sound types (such as the baby's cry, a washing machine's finish sound, a microwave oven's finish sound, etc.) are registered together with frequencies, frequency contours, etc. corresponding thereto.

Generally, the baby's cry varies more widely than a sound of the washing machine or microwave oven, and the pattern of the baby's cry varies according to a situation such as hunger, etc. Therefore, time-varying pattern of pitch/formant of the baby's cry may be sampled to provide plural recognition patterns so as to be recognized by a sound recognition module such as an MT (Mahalanobis-Taguchi) system and a modified MT system.

Usage examples of this embodiment will be described below with reference to FIGS. 4 to 6.

FIG. 4 illustrates the case where a cry (cr) of a baby who is sleeping in another room is detected. On this occasion, the amplified baby's cry (CR) is reproduced from the TV speaker which is being used. Generally, it is difficult for a parent (for example, a mother) to watch TV at ease at a distance from a baby during baby care. According to the embodiment, the parent can enjoy watching TV at ease after the parent has put the baby to sleep in a quiet room, thereby lightening the baby-care burden as a recent social issue.

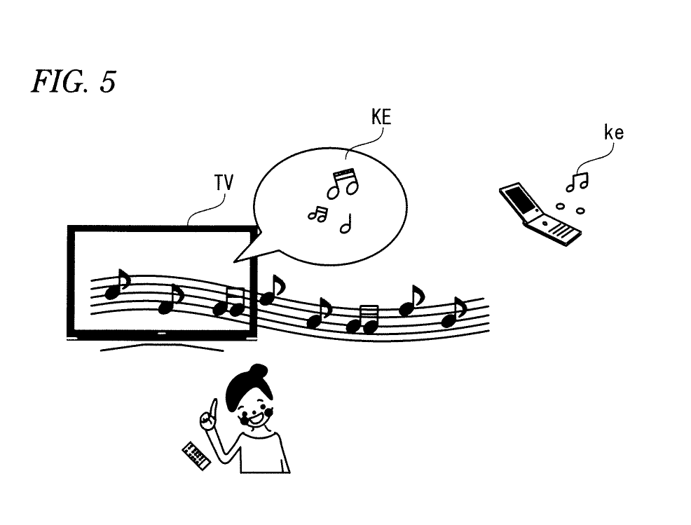

FIG. 5 illustrates the case where there is a ring tone (ke) to a cellular phone while the user is watching TV. On this occasion, the amplified ring tone (KE) is reproduced from the TV speaker which is being used.

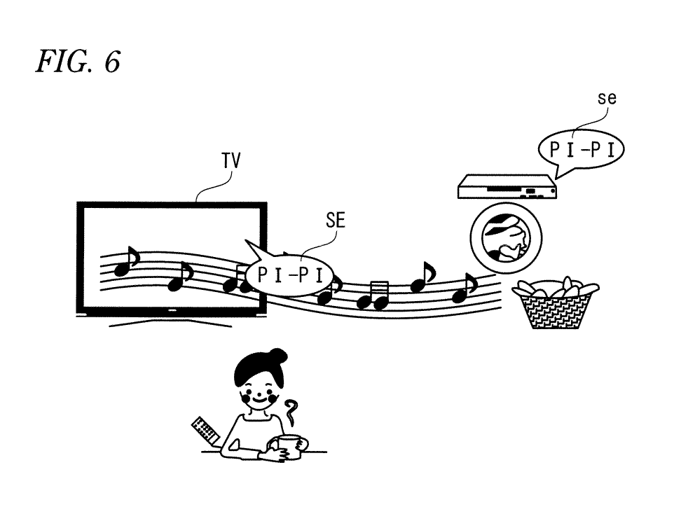

FIG. 6 illustrates the case where a notification sound (se) for notifying the user of the completion of washing is generated by a washing machine while the user is watching TV. On this occasion, the amplified notification sound (SE) is reproduced from the TV speaker which is being used.

By displaying a telop image in Steps S207 and S208 in any of the cases of FIGS. 4 to 6, the user can grasp the situation in the form like a “news flash”.

Generally, there is a fear that the user may fail to hear an important environmental sound in a real world because the important environmental sound is cancelled by currently-listened content sound during viewing/listening of video/audio. According to the embodiment, an apparatus capable of amplifying a noticeable environmental sound itself, superposing the amplified environmental sound on currently-listened content and outputting the superposed environmental sound can be achieved by an inexpensive and simple configuration. The user can accurately judge the important environmental sound with an extended sense of reality. Accordingly, for example, a housewife who is busy with baby care and housework can also secure a time to enjoy watching TV at ease, thereby lightening housework and baby-care burdens as an exemplary effect.

According to this embodiment, the video/audio playback apparatus has a sound information input module which inputs a surrounding environmental sound; a sound information management module which manages feature information of noticeable environmental sounds; a sound information analysis module which analyzes sound information inputted from the input module; a notification information creation module which creates notification information when the inputted sound information coincides with one of the noticeable environmental sounds; and an output control module which superposes the created notification information on currently-viewed video or currently-listened audio and outputs the superposed notification information. The above video/audio playback apparatus can automatically detect such an important environmental sound in a real world that the user would failed to hear during viewing/listening of video/audio, and can notify the user of the important environmental sound accurately.

This notification information is either or both of sound information received by amplifying the inputted sound and message information corresponding to the sound.

As described above, according to this embodiment, an environmental sound itself in a real world can be amplified and conveyed to the user with an extended sense of reality, so that the user can make an accurate judgment. For example, by previously registering voices of specific persons in the sound information management portion 113, the playback apparatus can be used as a house communication tool for a family.

The invention is not limited to the embodiment but may be modified and put into practice variously, for example, in the following manners without departing from the scope of the invention.

(1) The sound information database 115 may be built in the apparatus in advance, or may be configured to allow the user to arbitrarily register sound information in the sound information database 115 from the outside.

(2) The apparatus may be used as a house communication tool for a family, by registering voices of specific persons in the sound information database 115 and by a sound recognition module so that words vocalized by the specific persons can be reproduced.

When the MT system is used, a unit space (word/speaker recognition dictionary) can be constituted only by normal data (specific person's voices). For example, while each person is asked to produce voice as many as 20 times, the apparatus may simply extract and learn necessary components such as 256 items (=16 items for a frequency axis×16 items for a time axis) from the produced voice.

The above example has been described about a baby's cry. Alternatively, for example, voices of children near to the microphone may be filtered so that the playback apparatus is used to communicate with a specific member of the family staying in another room.

(3) When a noticeable environmental sound is detected during watching TV, since it might be necessary to temporarily stop TV watching, a time-shift playback process may be automatically performed.

Constituent elements in the embodiments may be combined suitably to form various inventions. For example, some constituent elements may be removed, and constituent elements in different embodiments may be combined suitably.

According to the embodiment, it is possible to provide a playback apparatus and a playback method for notifying a user of an important environmental sound during playback of video, audio, etc.

What is claimed is:

1. A playback apparatus comprising:
a sound information input module configured to receive a surrounding environmental sound as sound information;
a sound information management module configured to manage feature information of noticeable environmental sounds;
a sound information analysis module configured to analyze the received sound information;
a notification information creation module configured to create notification information when the received sound information coincides with the feature information of one of the noticeable environmental sounds; and
an output control module configured to output video or audio by superposing the created notification information thereon.

2. The apparatus of claim 1,
wherein the feature information is received by being extracted from the noticeable electronic sounds.

3. The apparatus of claim 2,
wherein the audio information analysis module filters other sounds than the noticeable electronic sounds.

4. The apparatus of claim 1,
wherein the feature information is received by being extracted from a voice of a specific person.

5. The apparatus of claim 4,
wherein the audio information analysis module filters other sounds than the voice of the specific person.

6. The apparatus of claim 1,
wherein the notification information is received by amplifying the noticeable environmental sound to be outputted.

7. The apparatus of claim 1,
wherein the notification information is a message composed of characters or video, corresponding to the sound information.

8. A playback apparatus comprising:
a sound information input module configured to receive a surrounding environmental sound as sound information;
a sound information management module configured to manage feature information of noticeable environmental sounds;
a sound information analysis module configured to analyze the received sound information; and
an output control module configured to play back video or audio in a time shift manner when the received sound information coincides with the feature information of one of the noticeable environmental sounds.

9. The apparatus of claim 4,
wherein the sound information and the feature information are extracted by using an MT system.

10. The apparatus of claim 1, further comprising:
a play back module configured to play back video or audio, based on an output of the output control module.

11. A playback method comprising:
receiving a surrounding environmental sound as sound information;
storing feature information of noticeable environmental sounds;
analyzing the received sound information;
creating notification information when the received sound information coincides with the feature information of one of the noticeable environmental sounds; and
outputting video or audio by superposing the created notification information thereon.
